(19) United States
(12) Patent Application Publication
(10) Pub. No.: US 2009/0086187 A1
(43) Pub. Date: Apr. 2, 2009

(54) Lithographic Apparatus and Device Manufacturing Method

(75) Inventors: Rene Theodorus Petrus COMPEN, Valkenswaard (NL); Martin Frans Pierre Smeets, Veldhoven (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands, DR Veldhoven (NL)

(21) Appl. No.: 12/189,546

(22) Filed: Aug. 11, 2008

Related U.S. Application Data
(60) Provisional application No. 60/935,381, filed on Aug. 9, 2007.

(51) Int. Cl. G03B 27/60; G03B 27/32

(52) U.S. Cl. 355/73; 355/77

(57) ABSTRACT

A clamping device can be configured to clamp an object on a support. The clamping device can include a first device configured to exert an attracting force on the object, and a second device configured to exert a rejecting force on the object. The first device and second device can be configured to simultaneously exert an attracting and a rejecting force on the object to shape the object to a desired shape before clamping of the object on the support. A method is provided for loading an object on a support, comprising the steps of shaping the object in a desired shape spaced from the support. The shaping can include subjecting the object simultaneously to an attracting force pulling the object toward the support and a rejecting force pushing the object away from the support, and clamping the object on the support.

### CROSS REFERENCE TO RELATED APPLICATIONS

This application claims priority to U.S. Application 60/935,381 filed Aug. 9, 2007. The subject matter of that application is incorporated herein as if fully set forth.

### BACKGROUND

1. Field of the Invention

The present invention relates to a clamping device and a method for clamping an object on a support. The present invention further relates to a lithographic apparatus and a method for clamping a substrate on a substrate support of a lithographic apparatus.

2. Description of the Related Art

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g., including part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In the known lithographic apparatus, each substrate to be exposed is loaded on a substrate support on which the substrate is supported during the exposure of a patterned beam of radiation. To clamp the substrate on the substrate support, a clamping device is provided. In a known embodiment of the lithographic apparatus, a vacuum clamping device is used. Such a vacuum clamping device provides a vacuum force with which the substrate is clamped on the supporting surface of the substrate support. In the case a straight substrate, the substrate will be clamped on the support surface without any substantial internal stresses in the substrate.

However, substrates may not be straight. For example, they may be warped in one or more areas to form various shapes, such as a corrugated shape, cylindrical shape, dome-shape, a saddle shape or some other shape. This may be caused by the production method used to make the substrate, or by pre- or post-exposure processes to which substrates are subjected during the manufacture.

When a warped substrate, for example, a dome-shaped substrate, is clamped onto a substrate support, for example, by means of a vacuum clamp, the substrate may first contact with the substrate support at an outer circumference of the substrate and thereafter over the rest of the surface of the substrate. Clamping at an outer circumference of the substrate may force it into a substantially straight. However, as a result, stresses may be induced in the substrate when it is clamped on the supporting surface.

These stresses may adversely affect the final product quality. The clamped forced re-shaping of the substrate may also adversely affect overlay performance of the projections of the lithographic apparatus in that they may not properly align thereby reducing product quality.

### SUMMARY

Applicants have determined that it is desirable to provide a substrate support having a holding arrangement for substrates, wherein internal stresses in a substrate due to clamping forces are substantially decreased. Furthermore, it is desirable to provide a clamping method with which a warped substrate may be clamped on a substrate support in a manner that does not introduce stresses in the substrate and/or the potential for overlay errors.

According to an aspect of the invention, there is provided a clamping device configured to clamp an object on a support, including a first device configured to exert an attracting force on the object, and a second device configured to exert a rejecting force on the object. The first device and second device are configured to simultaneously exert their respective attracting and a rejecting forces on the object to shape the object to a desired shape before clamping the object on the support.

According to an embodiment of the invention, there is provided a method for loading an object on a support, including shaping the object to a desired shape. The shaping includes subjecting the object simultaneously to an attracting force pulling the object towards the support and a rejecting force pushing the object away from the support. The resulting shaped object is clamped to the support.

According to an embodiment of the invention, there is provided a method for loading a substrate on a substrate support of a lithographic apparatus. The method includes shaping the substrate to a desired shape. The shaping includes subjecting the substrate simultaneously to an attracting force pulling the object toward the support and a rejecting force pushing the substrate away from the support. The resulting shaped object is clamped to the substrate support.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a side view of a substrate support according to the invention;

FIG. 3 depicts a top view of the substrate support of FIG. 2;

FIGS. 4a, 4b and 4c are diagrams showing examples of the dependence of the attracting force and the rejecting force on the distance between the substrate and the substrate support;

FIGS. 5a-5c depict three steps of a method according to the invention; and

FIGS. 6a-6c depict a side view of an alternative embodiment of a substrate support according to the invention, and three steps of a clamping method according to the invention.

### DETAILED DESCRIPTION

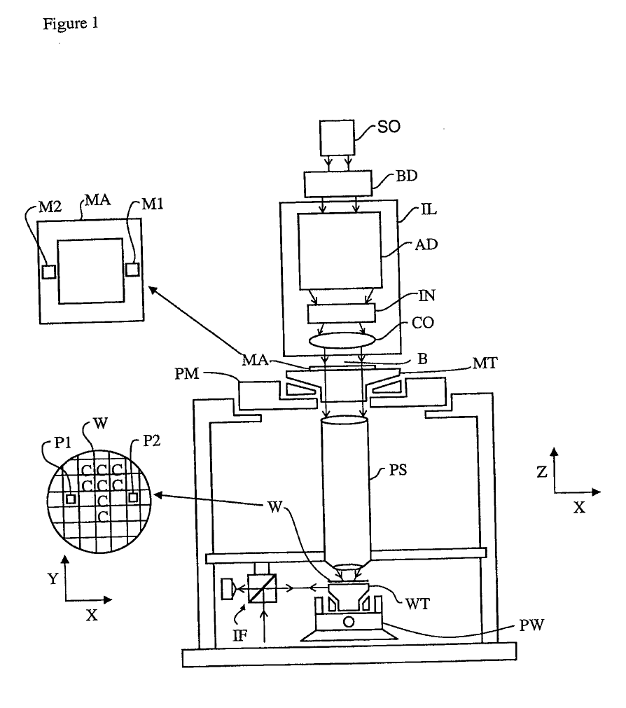

FIG. 1 schematically depicts a lithographic apparatus according to one embodiment of the invention. The apparatus includes an illumination system (illuminator) IL configured to condition a radiation beam B (e.g., UV radiation or any other suitable radiation), a mask support structure (e.g., a mask table) MT constructed to support a patterning device (e.g., a mask) MA and connected to a first positioning device PM configured to accurately position the patterning device MA in accordance with certain parameters. The apparatus also includes a substrate table (e.g., a wafer table) WT or “substrate support” constructed to hold a substrate (e.g., a resist-coated wafer) W and connected to a second positioning device PW configured to accurately position the substrate W in accordance with certain parameters. The apparatus further includes a projection system (e.g., a refractive projection lens system) PS configured to project a pattern imparted to the radiation beam B by patterning device MA onto a target portion C (e.g., including one or more dies) of the substrate W.

The illumination system IL may include various types of optical components, such as refractive, reflective, magnetic, electromagnetic, electrostatic or other types of optical components, or any combination thereof, for directing, shaping, or controlling radiation.

The mask support structure MT supports, i.e., bears the weight of, the patterning device MA. It holds the patterning device MA in a manner that depends on the orientation of the patterning device MA, the design of the lithographic apparatus, and other conditions, such as for example whether or not the patterning device MA is held in a vacuum environment. The mask support structure MT can use mechanical, vacuum, electrostatic or other clamping techniques to hold the patterning device MA. The mask support structure MT may be a frame or a table, for example, which may be fixed or movable as required. The mask support structure MT may ensure that the patterning device MA is at a desired position, for example with respect to the projection system PS. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam B may not exactly correspond to the desired pattern in the target portion C of the substrate W, for example if the pattern includes phase-shifting features or so-called assist features. Generally, the pattern imparted to the radiation beam B will correspond to a particular functional layer in a device being created in the target portion C, such as an integrated circuit.

The patterning device MA may be transmissive or reflective. Examples of patterning devices MA include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system.”

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual-stage) or more substrate tables or “substrate supports” (and/or two or more mask tables or “mask supports”). In such “multiple-stage” machines, the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g., water, so as to fill a space between the projection system PS and the substrate W. An immersion liquid may also be applied to other spaces in the lithographic apparatus, for example, between the mask MA and the projection system PS. Immersion techniques can be used to increase the numerical aperture of projection systems. The term “immersion” as used herein does not mean that a structure, such as a substrate, must be submerged in liquid, but rather only means that a liquid is located between the projection system PS and the substrate W during exposure.

FIG. 1 depicts a lithographic apparatus according to an embodiment of the invention. An illuminator IL receives a radiation beam B from a radiation source SO. The source SO and the lithographic apparatus may be separate entities, for example when the source SO is an excimer laser. In such cases, the source SO is not considered to form part of the lithographic apparatus and the radiation beam B is passed from the source SO to the illuminator IL with the aid of a beam delivery system BD including, for example, suitable directing mirrors and/or a beam expander. In other cases, the source SO may be an integral part of the lithographic apparatus, for example when the source SO is a mercury lamp. The source SO and the illuminator IL, together with the beam delivery system BD if required, may be referred to as a radiation system.

The illuminator IL may include an adjuster AD configured to adjust the angular intensity distribution of the radiation beam B. Generally, at least the outer and/or inner radial extent (commonly referred to as a-outer and a-inner, respectively) of the intensity distribution in a pupil plane of the illuminator IL can be adjusted. In addition, the illuminator IL may include various other components, such as an integrator IN and a condenser CO. The illuminator IL may be used to condition the radiation beam B, to have a desired uniformity and intensity distribution in its cross-section.

The radiation beam B is incident on the patterning device (e.g., mask MA), which is held on the mask support structure (e.g., mask table MT), and is patterned by the patterning device MA. Having traversed the mask MA, the radiation beam B passes through the projection system PS, which focuses the beam B onto a target portion C of the substrate W. With the aid of the second positioning device PW and position sensor IF (e.g., an interferometric device, linear encoder or capacitive sensor), the substrate table WT can be moved accurately, e.g., so as to position different target portions C in the path of the radiation beam B. Similarly, the first positioning device PM and another position sensor (which is not explicitly depicted in FIG. 1) can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner), the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT or “mask support” and the substrate table WT or “substrate support” are kept essentially stationary, while an entire pattern imparted to the radiation beam B is projected onto a target portion C at one time (i.e., a single static exposure). The substrate table WT or “substrate support” is then shifted in the X and/or Y direction so that a different target portion C can be exposed. In step mode, the maximum size of the exposure field limits the size of the target portion C imaged in a single static exposure.

2. In scan mode, the mask table MT or “mask support” and the substrate table WT or “substrate support” are scanned synchronously while a pattern imparted to the radiation beam B is projected onto a target portion C (i.e., a single dynamic exposure). The velocity and direction of the substrate table WT or “substrate support” relative to the mask table MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT or “mask support” is kept essentially stationary holding a programmable patterning device, and the substrate table WT or “substrate support” is moved or scanned while a pattern imparted to the radiation beam B is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes a programmable patterning device, such as a programmable mirror array of a type as referred to above.

Combinations and/or variations on the above described modes of use or entirely different modes of use may also be employed.

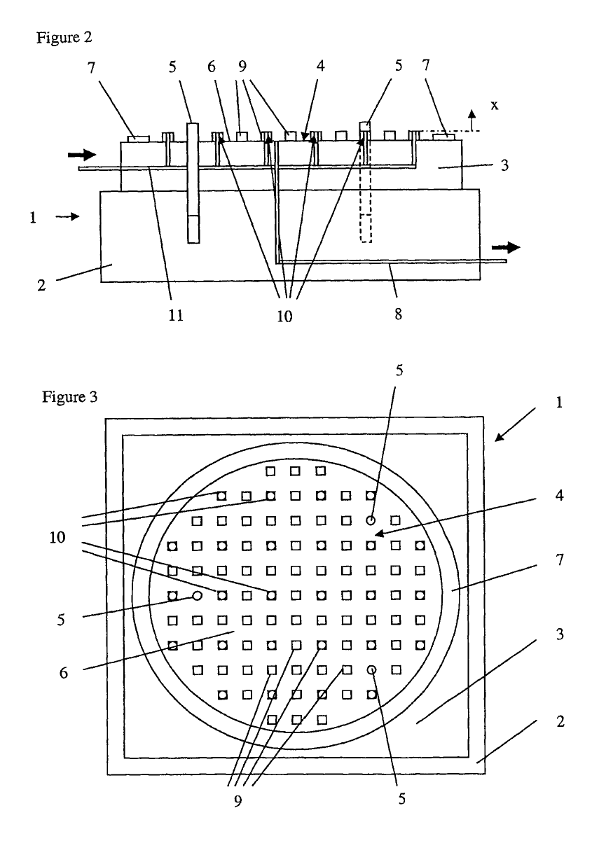

FIGS. 2 and 3 show a side view and top view of a substrate support according to the invention, respectively. The substrate support is generally indicated with the reference numeral 1. The substrate support 1 comprises a mirror block 2 on which a substrate table 3 is placed.

The top side of the substrate support 1 comprises a vacuum clamp 4 which is constructed and arranged to clamp a substrate on the substrate support 1. The substrate support 1 further includes three retractable pins 5, often referred to as e-pins, which are movable with respect to the substrate support 1 between an extended position in which the pins 5 extend from the substrate support 1 and a retracted position in which the pins 5 are retracted in the substrate support 1. The retractable pins 5 are movable in a substantially vertical direction, i.e., in a direction substantially perpendicular to a main plane of a substrate to be supported by the pins 5. The retractable pins 5 may be used for transfer of a substrate between the substrate support 1 and a robot or any other type of substrate handler. The retractable pins 5 are provided so that a robot may be placed under the substrate for supporting it. When the robot is configured to hold the substrate at the sides or top, the retractable pins 5 may be omitted. In alternative embodiments, any other type of device capable of exerting an attraction force on a substrate, such as electrostatic, magnetic or electromagnetic clamps may be used.

A robot may place a substrate on the pins 5 while the pins 5 are in the extended position. Then the pins 5 may be moved to the retracted position so that the substrate comes to rest on the support surface of the substrate support 1. After a substrate supported by the substrate support 1 is exposed to a patterned beam of radiation, it may be exchanged for another one. For exchange of the substrate, it is lifted from the substrate table 3 by the retractable pins 5 which are moved from the retracted position to the extended position. When the pins 5 are in the extended position, the substrate may be taken over by the robot or any other type of substrate handler.

The vacuum clamp 4 is formed by a recessed surface 6 which is surrounded by a sealing rim 7. A suction conduit 8 is provided to create a low pressure in a vacuum space delimited by the recessed surface 6, the sealing rim 7 and a substrate placed or to be placed on the substrate support 1. The suction conduit 8 is connected to a suction pump to draw air, or another gas present in the process environment, out of the vacuum space. The lower pressure provides a vacuum force which draws a substrate placed within a certain range above the supporting surface towards the substrate support 1. In this range, or at least a part thereof, the vacuum force exerted on the substrate may be substantially independent of the distance x between the substrate support 1 and the substrate.

In the recessed surface 6, a number of burls 9 are arranged. The top ends of the burls 9 provide support surfaces for a substrate to be placed on the substrate support 1. The sealing rim 7 and the top ends of the burls 9 may be arranged in substantially the same plane to provide a substantial flat surface for supporting a substrate. In an alternative embodiment, the sealing rim 7 may be arranged lower than the burls 9, as shown in FIG. 2, or vice versa.

In an embodiment of the substrate support 1, two or more vacuum clamps may be provided. Also another device for providing an attracting force exerted on the substrate, i.e., a force pulling the substrate towards the substrate support, may be provided, such as an electrostatic, magnetic, or electromagnetic clamp. The force exerted by such clamp can be in a range above a supporting surface of the substrate support 1 independent of the distance x between the substrate support 1 and the substrate.

In a number of burls 9, nozzles 10 are provided. In the embodiment shown in FIGS. 2 and 3, the nozzles 10 are evenly distributed over the surface area delimited by the sealing rim 7. They may be unevenly distributed in other embodiments. The nozzles 10 are connected to a gas supply conduit 11 and are configured to provide a jet in a direction substantially perpendicular to the recessed surface 6, i.e., substantially perpendicular to the main plane of a substrate to be arranged on the substrate support 1. To actually provide a jet, a pump (not shown), or another source of pressurized gas, is connected to the supply conduit 11. In an alternative embodiment of the substrate support, the nozzles 10 are not integrated in the burls 9, but are separately provided. The gas passing through conduit 11 and the jets may be any suitable gas, such as, for example, air.

A substrate placed in the above-mentioned range is subject to a force exerted by the jet which is dependent on the distance x between the substrate support 1 and the substrate.

In an alternative embodiment, other devices may be employed to provide a rejecting force, i.e., a force pushing the substrate away from the substrate support 1. Such devices may, for example, include linear or non-linear springs, or electrostatic, magnetic or electromagnetic devices. The rejecting force exerted on the substrate can be provided in such a way that it decreases with increasing distance x between substrate support 1 and substrate.

Generally, the rejecting force and the attracting force can be provided by a device which is capable of exerting a force on the substrate without mechanical contact between the respective force exerting device and the substrate.

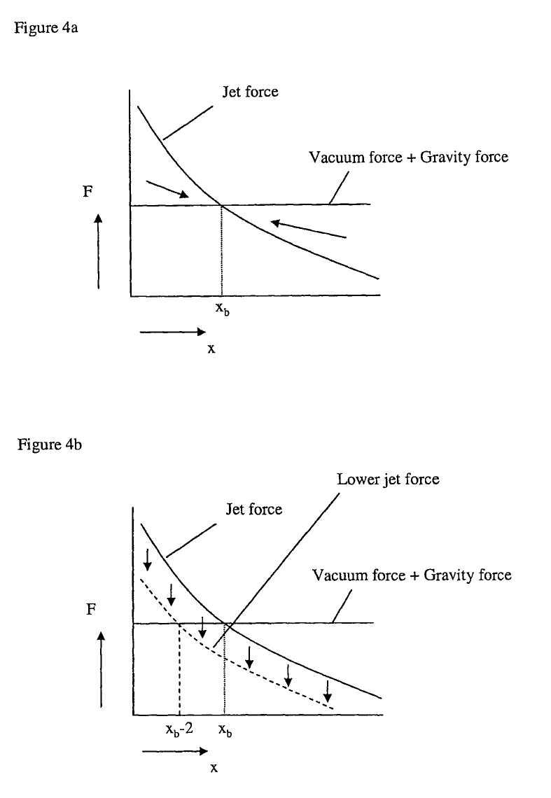

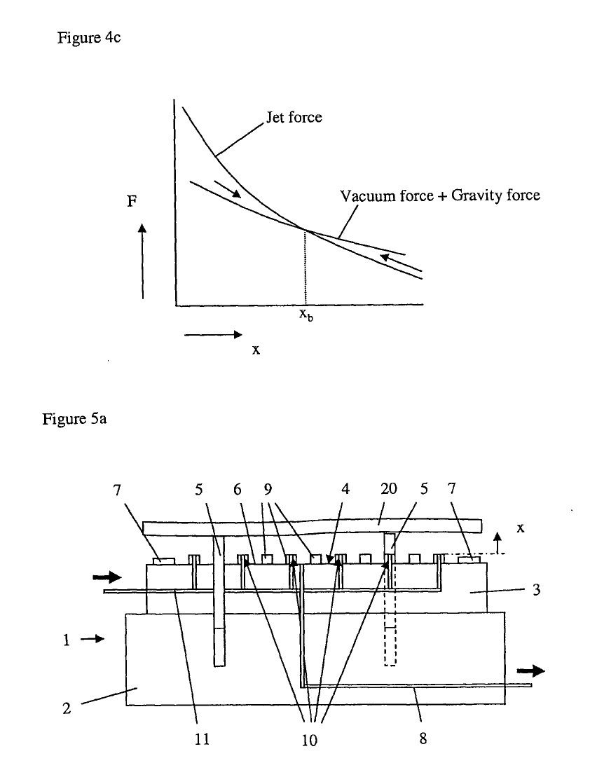

FIGS. 4a, 4b and 4c are diagrams showing examples of the dependence of the attracting force and the rejecting force on the distance between the substrate and the substrate support. In FIG. 4a, the attracting vacuum force plus gravity force, and the rejecting jet force exerted on the substrate are shown in dependence on the distance x of the substrate from the substrate support 1. On the x-axis, the distance x between the substrate support 1 and the substrate is indicated for a certain range. On the y-axis, the attracting force (combination of vacuum force and gravity force) and the rejecting force (et force) are shown in dependence of the distance x.

In the range shown, the attracting force is independent of the distance x. The rejecting force caused by the jets decreases with increasing distance x. At the balance distance X_{b}, the attracting force and the rejecting force are equal. When a substrate is present at this balance distance it will be held at this distance since these forces are equal. At distances larger than X_{b}, the attracting force is larger than the rejecting force and, as a result, the substrate will move towards the substrate support 1, therewith decreasing the distance X. At distances smaller than X_{b}, the attracting force will be smaller than the rejecting force, and the substrate will be moved away from the substrate support 1 to the balance position X_{b}. In this way, the substrate may be held and moved towards a balance position X_{b} as indicated by arrows in FIG. 4a.

Furthermore, not only the substrate as a whole will be moved towards the balance position. The balance between the attracting force and the rejecting force also may be used to shape the warped substrate to a desired shape. This may be advantageous in the case when a substrate to be loaded on the substrate support is warped. When the balance distance X_{b} is equal for the whole surface area of a substrate supported on the substrate support 1, the warped substrate may be straightened at the distance X_{b}, by balancing it for a certain time at this distance using the attracting and rejecting forces of the substrate support 1 before it is clamped on the supporting surface of the substrate support 1.

In an embodiment, the straightening, or more generally the shaping, also may be performed while the substrate is moved towards the substrate support. In such an embodiment, the balance distance X_{b} is decreased during shaping, therewith moving the substrate towards the substrate support 1. The change in balance distance may be obtained by changing the attracting force and/or the rejecting force accordingly. For instance, in FIG. 4b, is shown in dashed lines that the rejecting force is lowered resulting in another balance distance X_{b}−2, which is closer to the substrate support 1.

In an embodiment, unevenly distributed attracting and/or rejecting forces may be provided, for instance by an unevenly distributed number of nozzles or a difference in the jetting force or vacuum force by using different supply conduits or two or more vacuum clamps, each of which can have its own suction conduit. In such an embodiment, the balance distance X_{b} may be varied along the surface area of the substrate and, as a result, the substrate may be formed in a desired shape.

In an embodiment, it may be possible that both forces depend on the distance x between the substrate support 1 and the substrate 20. For instance, in FIG. 4c the attracting force, i.e., vacuum force plus gravity force, and the rejecting force, i.e., jet force, exerted on the substrate both decrease with increasing distance between the substrate support 1 and the substrate. However, at shorter distances, smaller than X_{b} the rejecting force is larger and at distances larger than X_{b} the attracting force is larger. Thus, the substrate will be held at the distance X_{b}, therewith creating the possibility of shaping the substrate, for instance straightening a warped substrate before clamping it on the substrate support 1.

With respect to the diagrams shown in FIGS. 4a and 4b and the embodiments shown in the other figures, it is remarked that in these embodiments the gravity force is part of, or forms, the attracting force since the substrate is clamped on the top side of the support 1. In alternative embodiments, the substrate may be clamped on the bottom side of a support, in which case, gravity will be part of, or form, the rejecting force, or the substrate may be clamped at the side of a support, in which case the gravity force will not play a role in the balance between the attracting force and the rejecting force.

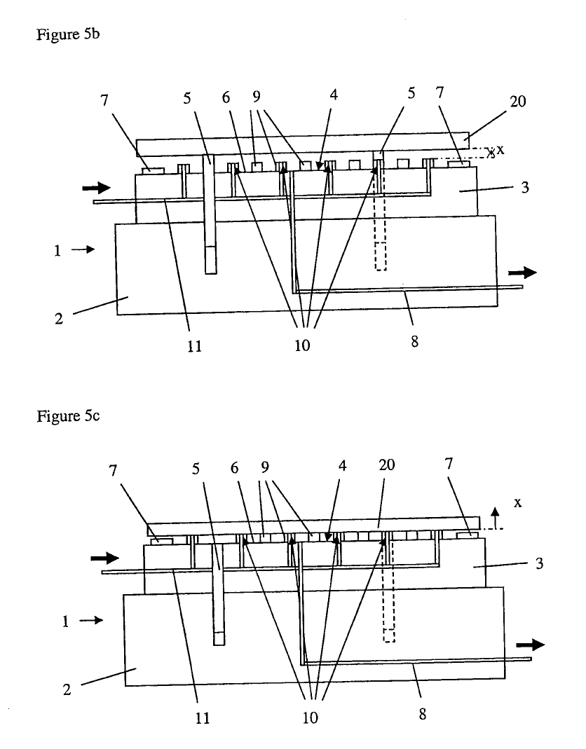

FIGS. 5a-5c show some steps of a clamping method according to the invention for clamping a warped substrate 20 on a substrate support 1.

FIG. 5a shows the substrate support 1 of FIG. 2 whereby a substrate 20 is placed on the retractable pins 5. The substrate 20 is warped, which for instance may be caused by a pre- or post-exposure process such as coating, baking, chilling or developing of the substrate 20. The height differences in the substrate are typically in the range of 5-50 micrometers, in particular for relatively new substrates, which have not been processed, for instance coated, baked, chilled and developed. Differences up to 450 micrometers or even more are also possible, for example, after the substrates have been processed.

When such a warped substrate 20 is loaded on the substrate support 1 without further measures, stresses may be introduced in the substrate 20 due to the clamping of the substrate 20 in the warped form. For instance, when the substrate 20 is dome-shaped, first the outer circumference may be clamped and thereafter the middle of the substrate 20 is clamped. As the circumference of the warped substrate 20 may be smaller than the circumference of the same straightened substrate, the clamping may result in stresses in the substrate 20.

In FIG. 5b, the substrate 20 is moved downwardly by retracting the pins 5 in the substrate support 1 to bring the substrate 20 close to the balance position, i.e., the distance x between substrate 20 and substrate support 1 close to X_{b}. The balance distance X_{b} may lie within the range 1-1000 micrometer, or in some exemplary embodiments, in the range 1-100 micrometer. The desired balance distance may also depend on the height differences which are present in a respective substrate.

To shape a warped substrate, an attracting force and a rejecting force are simultaneously exerted on the substrate. The magnitude of these forces may be altered to change the balance position of the substrate.

Thereby, it may be possible that the substrate is shaped during movement of the substrate towards the substrate support. Also, the substrate may be shaped during a first approach of the substrate support 1 and then be held at a certain distance, for instance between 1 and 100 micrometer to be further shaped to a substantially flat form before it is clamped on the substrate support 1.

Since the substrate 20 floats on a fluid bed created by the jets, some fixation for the substrate also can be provided. For this reason, the substrate 20 is still held by the retractable pins 5 for fixation in the x, y and Rz directions. However, to make the influence of the presence of the pins 5 on the straightening as small as possible, the pins 5 have at least during the straightening phase a low stiffness in the vertical z-direction. Any other device for maintaining the substrate in substantially the same position in x, y and Rz directions also may be used.

When the straightening of the substrate 20 has finished, the substrate 20 is clamped on the substrate support 1 by making the attracting force larger than the rejecting force, for instance by increasing the vacuum force of the vacuum clamp 4 or by decreasing the velocity of the jets coming from the nozzles 10. As a consequence, the substrate 20 comes to rest on the support surface of the substrate support 1. When the vacuum force is maintained, the substrate 20 is clamped on the substrate support 1 while still being in a substantially straightened shape.

In FIG. 5c, the substrate 20 is shown clamped on the substrate support 1 using the vacuum clamp 4. Since the substrate 20 is straightened during clamping on the substrate support 1, the risk of internal stresses in the substrate 20 is substantially reduced and the overlay performance is therewith increased. The retractable pins 5 are moved to the retracted position.

The straightening phase also may be used for thermal conditioning of the substrate 20 by temperature control of the gas used for the jets.

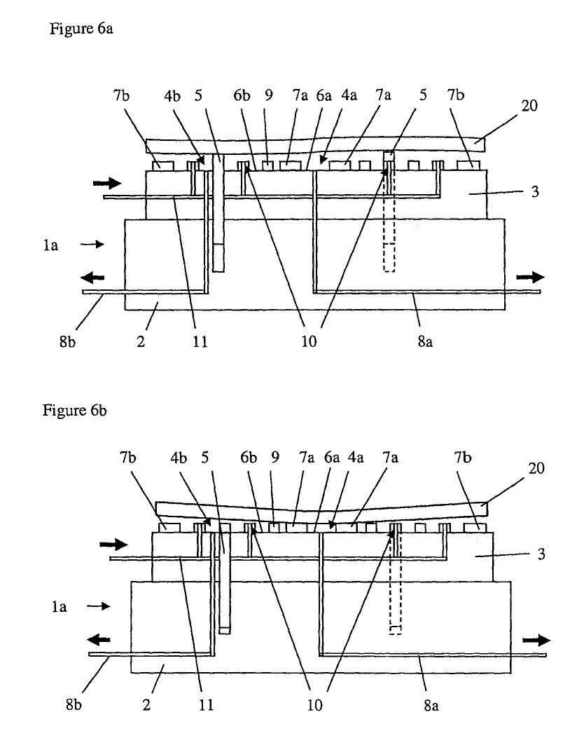

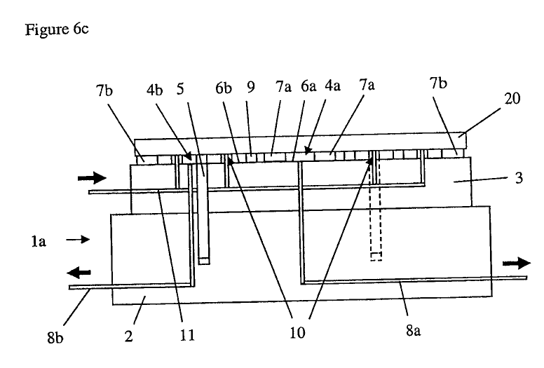

FIGS. 6a-6c show a side view of an alternative embodiment of a substrate support 1a according to the invention. Each of the FIGS. 6a-6c shows a step during shaping and clamping of a warped substrate 20 on the substrate support 1a. Features of substrate support 1a having the same or substantially the same function as in the embodiment of FIGS. 2, 3 and 5a-5c have been given the same reference numerals.

The top side of the substrate support 1a comprises a first vacuum clamp 4a and a second vacuum clamp 4b to clamp a substrate 20 on the substrate support 1a. The first vacuum clamp 4a is configured to clamp a center part of a substrate 20 and is delimited by the circular inner sealing rim 7a. A gas suction conduit 8a is provided to draw gas out of a vacuum space defined by a recessed surface 6a and sealing rim 7a.

The second vacuum clamp 6b is annular and concentrically surrounds the first vacuum clamp 6a. The second vacuum clamp 6b is configured to clamp a circumferential area of a substrate 20 surrounding the center part of the substrate 20. The second vacuum clamp 4b is delimited by the inner sealing rim 7a and a circular outer sealing rim 7b. A gas suction conduit 8b is provided to draw gas out of a vacuum space defined by a recessed surface 6b between the inner sealing rim 7a and the outer sealing rim 7b.

In the recessed surface 6b, several burls 9 are arranged. The top ends of the burls 9 provide in combination with top ends of inner sealing rim 7a and outer sealing rim 7b support surfaces for a substrate 20 to be placed on the substrate support 1a.

In a number of burls 9, nozzles 10 are provided. The nozzles 10 are arranged in the burls 9 in the recessed area 6b so that a rejecting force may be exerted on another part of a substrate 20 than the center part of the substrate 20. The nozzles 10 are connected to a gas supply conduit 11 and are configured to provide a jet substantially perpendicular to the main plane of a substrate 20 supported or to be supported on the substrate support 1a.

FIG. 6a-6c show some steps of an alternative clamping method according to the invention for clamping a substrate 20 on a substrate support 1a.

FIG. 6a shows the substrate support 1a, whereby a substrate 20 is placed on the retractable pins 5. The substrate 20 is warped, which for instance may be caused by a pre- or post-exposure process, such as coating, baking, chilling or developing of the substrate 20. In the present exemplary method, the pins 5 are lowered until the substrate 20 is at least partially supported on the substrate support 1a. Then the first vacuum clamp 6a clamps the center part of the substrate 20 on the support 1a. Thereafter, the substrate 20 is brought into a desired cup or concave shape by jetting air or another suitable gas out of the nozzles 10.

In FIG. 6b, the substrate 20 is shown in the cup or concave-shaped state. During this state, the second clamping device 4b may exert an attracting force on the substrate 20, but the jetting force exerted by gas jets emerging from the nozzles 10 is larger so that the circumferential part of the substrate 20 bends up from the substrate support 1a to form the cup or concave shape as shown in FIG. 6b.

Since, in this state, the substrate 20 is clamped by the first vacuum clamp 4a at the center part of the substrate 20, fixation for the substrate 20 is provided in the x, y and Rz directions. Undesired floating of the substrate 20 in these directions is substantially prevented, while the pins 5 may be fully retracted in the substrate support 1a and have no mechanical influence on the substrate 20.

When the attracting force of the second vacuum clamp is gradually increased and/or the rejecting force of the jets is gradually decreased, the substrate 20 will be clamped on the substrate support 1a in radial direction starting from the central part. As a result, the substrate 20 will be clamped on the substrate support 1a without or with substantially decreased internal stresses since the substrate 20 is gradually “rolled out” on the substrate support 1a to a substantially straight state as shown in FIG. 6c. As a result, overlay errors may be avoided.

In alternative embodiments it may be possible that the first clamping device is not configured to clamp, at first instance, a center part of a substrate 20, but another part of the substrate 20, for instance an edge of a substrate 20. In such an embodiment, the substrate 20 may be clamped on the substrate support 1a after shaping the substrate 20 in a form wherein it is only clamped at that part, starting from this part of the substrate 20.

In the embodiment shown in FIGS. 6a-6c, the first and second vacuum clamp 4a and 4b in combination exert an attracting force on the whole surface area of the substrate 20. In another embodiment, a first clamping device may be provided to exert a clamping force on only a part of a substrate, and a second clamping device may be provided to exert a clamping force on the whole surface area of the substrate. In such an embodiment, the first clamping device may be used as a pre-clamping device configured to hold only a part of the substrate during shaping and the second clamping device may be used as clamping device during the actual lithographic process. Any suitable clamping device, such as vacuum clamp, electrostatic, magnetic or electromagnetic device may be used as clamping device.

In the embodiment shown in FIGS. 6a-6c, nozzles 10 are provided in the recessed surface 6b. In alternative embodiments, nozzles 10 may also be provided in the recessed area 6a as long as during shaping the attracting force of the first vacuum clamp is larger than the jetting force of jets emerging from those nozzles in the inner recessed area 6b. In another embodiment, the nozzles 10 may be provided only at the circular edge of the substrate support 1a, thus being configured to exert a rejecting force on only the circumferential edge of a substrate to be placed on the substrate support 1a.

In an embodiment of the substrate support 1a, different groups of nozzles may be provided, each group being connected to a separate gas supply conduit. Such an embodiment makes it possible that each group of nozzles may be used to provide a different jetting force, therewith making more accurate control of the forces exerted on the substrate possible.

In such an embodiment, the groups of nozzles can be arranged in concentric circles around the first clamping device configured to clamp a part of a substrate during shaping of the substrate. Also, the second vacuum clamp, or more generally the second clamping device, may be subdivided in a number of concentrically or otherwise arranged clamping devices to make more accurate control of the attracting forces exerted on different parts of a substrate possible.

Any suitable type of device for exerting a rejecting force on a substrate such as nozzles, electrostatic, magnetic or electromagnetic device may be used.

Above, the use of devices and methods for controlling the shape of an object before clamping it on a support is explained at the hand of a substrate support 1 and a substrate 20 to be clamped on such a support. Such a device and method may be used for clamping another object, for example a warped plane-shaped object, such as a warped plate or sheet, on a support in order to control the shape in which the object is clamped on the support, for example to avoid internal stresses in the object after clamping. Such embodiments are deemed to fall within the scope of the present invention.

Although specific reference may be made in this text to the use of a lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. In the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography, a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 248, 193, 157 or 126 nm) and extreme ultra-violet (EUV) radiation (e.g., having a wavelength in the range of 5-20 nm), as well as particle beams, such as ion beams or electron beams.

The term “lens,” where the context allows, may refer to any one or combination of various types of optical components, including refractive, reflective, magnetic, electromagnetic and electrostatic optical components.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

What is claimed is:

1. A clamping device configured to clamp an object on a support, comprising:
a first device configured to exert an attracting force on the object, and a second device configured to exert a rejecting force on the object, wherein the first device and second device are configured to simultaneously exert the attracting and rejecting forces on the object to shape the object to a desired shape before it is clamped on the support.

2. The clamping device of claim 1, wherein the first device and second device are configured to simultaneously exert the attracting and rejecting forces such that, at a balance distance with respect to the support, the attracting force and a gravity force on the object are equal to the rejecting force.

3. The clamping device of claim 2, wherein the first and second devices are constructed and arranged to hold the object at the balance distance during at least a period of the shaping of the object.

4. The clamping device of claim 2 or 3, wherein the first device and second device are configured and arranged to change the balance distance during shaping to move the object toward the support during at least a period of the shaping.

5. The clamping device of claim 1, wherein the first and second devices are constructed and arranged such that in a certain range, the attracting force is substantially independent of a distance between the support and the object, and wherein the rejecting force is dependent on the distance such that the rejecting force decreases as the distance between the object and the support increases.

6. The clamping device of claim 1,
wherein the first and second devices are constructed and arranged such that the attracting force is dependent on a distance between the object and the support,
wherein the rejecting force is dependent on the distance, and
wherein, within a range of distances between the object and the support, there is a balance distance, in which the attracting force and the rejecting force are equal.

7. The clamping device of claim 6, wherein the first and second devices are constructed and arranged such that,
within the range at distances smaller than the balance distance, the rejecting force is larger than the attracting force, and
at distances larger than the balance distance, the rejecting force is smaller than the attracting force.

8. The clamping device of claim 1, wherein the first device is configured to exert the attracting force on a part of the object, and wherein the second device is configured to exert the rejecting force on at least another part of the object.

9. The clamping device of claim 8, wherein the part of the object is a center part of the object, and the at least another part at least partially surrounds the center part.

10. The clamping device of claim 8 or 9, wherein the clamping device comprises a third device configured and arranged to exert, alone or in combination with the first device, an attracting force on substantially the whole surface of the object.

11. The clamping device of claim 1, wherein the first device comprises at least one vacuum clamp or electrostatic clamp.

12. The clamping device of claim 1, wherein the first device is configured and arranged to exert the attracting force on substantially the whole surface of the object.

13. The clamping device of claim 1, wherein the second device comprises a number of nozzles.

14. The clamping device of claims 11, wherein the support has a recessed surface surrounded by a sealing rim, the recessed surface being configured to serve as at least part of the vacuum clamp when gas is drawn out of a space defined at least partially by the recessed surface.

15. The clamping device of claim 14, wherein burls are arranged on the recessed surface, the burls providing support surfaces for an object clamped on the support.

16. The clamping device of claim 14 or 15, wherein a number of nozzles is provided in the recessed surface, the nozzles being connected to a pressure source and arranged to provide a jet of gas towards an object being held above the support.

17. The clamping device of any of the claims 13-15, wherein the nozzles are integrated in the burls.

18. The clamping device of claim 1, wherein the first device is configured and arranged to exert the attracting force on the object without mechanical contact between the first device and the object.

19. The clamping device of claim 1, wherein the second device is configured and arranged to exert the rejecting force on the object without mechanical contact between the second device and the object.

20. The clamping device of claim 1, wherein the support is a substrate support of a lithographic apparatus and the object is a wafer.

21. A method for loading an object on a support, comprising:
shaping the object to a desired shape, wherein the shaping comprises subjecting said object simultaneously to an attracting force pulling the object towards the support and a rejecting force pushing the object away from the support, and
clamping the object on the support.

22. The method of claim 21, further comprising holding the object at a certain distance from the support during at least a period of the shaping of the object.

23. The method of claim 21 or 22, further comprising moving the object during at least a period of the shaping towards the support.

24. The method of any of the claims 21-22, wherein the shaping comprises straightening of the object.

25. The method of any of the claims 21-22, wherein, within a range of distances between the object and the support:
the attracting force is substantially non-dependent on the distance between the object and the support, and
the rejecting force is dependent on the distance between the object and the support.

26. The method of any of the claims 21-22, wherein the attracting force is dependent on the distance between the object and the support,
wherein the rejecting force is dependent on the distance, and
wherein, within a range of distances between the object and the support, there is a balance distance, in which the attracting force and the rejecting force are equal.

27. The method of claim 26, wherein, within the range:
at distances smaller than the balance distance, the rejecting force is larger than the attracting force, and
at distances larger than the balance distance, the rejecting force is smaller than the attracting force.

28. The method of any of the claims 21-22, wherein the attracting force is created by at least one vacuum clamp or electrostatic clamp of the support.

29. The method of any of the claims 21-22, wherein the attracting force is at least partially created by gravity.

30. The method of any of the claims 21-22, wherein the shaping comprises exerting an attracting force on a part of the object, and exerting a rejecting force on at least another part of the object.

31. The method of claim 30, wherein the part of the object is clamped on the support.

32. The method of claim 30, wherein the part includes a center part of the object.

33. The method of any of the claims 30, wherein the another part at least partially surrounds the part.

34. The method of claim 3133, wherein the object is clamped on the support by decreasing the rejecting force and/or increasing the attracting force, thereby increasing the surface area of the object clamped on the support starting from the part.

35. A lithographic apparatus comprising a clamping device according to claim 1, wherein the support is configured to serve as a substrate support which is configured to support a substrate as the object.

36. A method for loading a substrate on a substrate support of a lithographic apparatus, the method comprising:
shaping the substrate in a desired shape spaced from the substrate support, wherein the shaping comprises subjecting the substrate simultaneously to an attracting force pulling the substrate toward the support and a rejecting force pushing the substrate away from the support, and
clamping the shaped substrate on the substrate support.
